(19) United States
(12) Patent Application Publication
(10) Pub. No.: US 2020/0086388 A1
(43) Pub. Date: Mar. 19, 2020

(54) Additive Manufacturing System with Addressable Array of Lasers and Real Time Feedback Control of each Source

(71) Applicant: Nuburu, Inc., Centennial, CO (US)

(72) Inventors: Mark S. Zediker, Castle Rock, CO (US); Mathew Silva Sa, Parker, CO (US); Jean Michel Pelaprat, Saratoga, CA (US); Mathew Finuf, Castle Rock, CO (US); Robert Fritz, Aurora, CO (US)

(73) Assignee: Nuburu, Inc., Centennial, CO (US)

(21) Appl. No.: 16/558,140

(22) Filed: Sep. 1, 2019

Related U.S. Application Data
(63) Continuation-in-part of application No. 15/210,765, filed on Jul. 14, 2016.
(60) Provisional application No. 62/726,234, filed on Sep. 1, 2018.
(60) Provisional application No. 62/193,047, filed on Jul. 15, 2015.

(51) Int. Cl. B22F 3/105; B23K 26/06; B23K 26/03

(52) U.S. Cl. CPC B22F 3/1055; B23K 26/0604; B23K 26/032; B23K 26/0648; B33Y 30/00; B22F 2301/10; B22F 2301/255; B22F 2301/052; B22F 2003/1056

(57) ABSTRACT

There is provided assemblies for combining a group of laser sources into a combined laser beam. There is further provided a blue diode laser array that combines the laser beams from an assembly of blue laser diodes. There are provided laser processing operations and applications using the combined blue laser beams from the laser diode arrays and modules.

This application: (i) claims under 35 U.S.C. § 119(e)(1) the benefit of the filing date of, and claims the benefit of priority to, U.S. provisional application Ser. No. 62/726,234 filed Sep. 1, 2018; and (ii) is a continuation-in-part of U.S. patent application Ser. No. 15/210,765, filed Jul. 14, 2016, which claims under 35 U.S.C. § 119(e)(1) the benefit of U.S. provisional application Ser. No. 62/193,047, filing date Jul. 15, 2015, the entire disclosures of each of which are incorporated herein by reference.

### BACKGROUND OF THE INVENTION

### Field of the Invention

The present inventions relate to array assemblies for combining laser beams; and in particular array assemblies that can provide high brightness laser beams for use in systems and applications in manufacturing, fabricating, entertainment, graphics, imaging, analysis, monitoring, assembling, dental and medical fields.

Many lasers, and in particular semiconductor lasers, such as laser diodes, provide laser beams having highly desirable wavelengths and beam quality, including brightness. These lasers can have wavelengths in the visible range, UV range, IR range and combinations of these, as well as, higher and lower wavelengths. The art of semiconductor lasers, as well as other laser sources, e.g., fiber lasers, is rapidly evolving with new laser sources being continuously developed and providing existing and new laser wavelengths. While having desirable beam qualities, many of these lasers have lower laser powers than are desirable, or needed for particular applications. Thus, these lower powers have prevented these laser sources from finding greater utility and commercial applications.

Additionally, prior efforts to combine these types of laser have generally been inadequate, for among other reasons, difficulty in beam alignment, difficulty in keeping the beams aligned during applications, loss of beam quality, difficulty in the special placement of the laser sources, size considerations, and power management, to name a few.

Infrared (IR) based (e.g. having wavelengths greater than 700 nm, and in particular greater than 1,000 nm) additive manufacturing systems which use a galvanometer scanner suffer from, among other things, two short comings, which both limit the build volume and the build speed. In these IR laser systems, the build volume is limited by the finite size of the scanning system and the spot that can be created for a given focal length collimator and f-theta lens. For example, when using a 140 mm focal length collimator and a 500 mm F-theta focal length lens the spot size for a 1 μm laser is approximately 40 μm for a near diffraction limited single mode laser. This gives an addressable foot print on the powder bed that is approximately 175 mm×175 mm, which is the limitation on the part size that can be built. The second limitation on the build speed for an IR laser system is the absorption of the laser beam by the powder material. Most raw materials have a modest to high reflectivity for wavelengths in the infrared spectrum. As a consequence, the coupling of the infrared laser energy into the powder bed is limited with a significant portion of the energy being reflected away, backward or deeper into the powder bed. These limitations are in a way further tied or linked together, compounding the problems and deficiencies of IR additive systems. Thus, the finite penetration depth of the infrared light determines the optimum layer thickness and as a consequence, limits the resolution and speed of the process. These and other failings of IR based manufacturing and building systems and processes have not been adequately addressed. Thus, not meeting the long felt need for improvements in additive manufacturing systems and processes.

As used herein, unless expressly stated otherwise, the terms “blue laser beams”, “blue lasers” and “blue” should be given their broadest meaning, and in general refer to systems that provide laser beams, laser beams, laser sources, e.g., lasers and diodes lasers, that provide, e.g., propagate, a laser beam, or light having a wavelength from 400 nm to 500 nm, and about 400 nm to about 500 nm. Blue lasers include wavelengths of 450 nm, of about 450 nm, of 460 nm, of about 460 nm. Blue lasers can have bandwidths of from about 10 pm to about 10 nm, about 5 nm, about 10 nm and about 20 nm, as well as greater and smaller values.

As used herein, unless expressly stated otherwise, “UV”, ultraviolet”, “UV spectrum”, and “UV portion of the spectrum” and similar terms, should be given their broadest meaning, and would include light in the wavelengths of from about 10 nm to about 400 nm, and from 10 nm to 400 nm.

As used herein, unless expressly stated otherwise, the terms “visible”, “visible spectrum”, and “visible portion of the spectrum” and similar terms should be given their broadest meaning, and would include light in the wavelengths from about 380 nm to about 750 nm, and 400 nm to 700 nm.

As used herein, unless expressly stated otherwise, the terms “green laser beams”, “green lasers” and “green” should be given their broadest meaning and in general refer to systems that provide laser beams, laser beams, laser sources, e.g., lasers and diode lasers, that provide, e.g. propagate, a laser beam or light having a wavelength range from 500 nm to 700 nm and about 500 nm to about 700 nm. Green lasers include wavelengths of 515 nm, of about 515 nm, of 550 nm, and of about 550 nm. Green lasers can have bandwidths of from about 10 pm to 10 nm, about 5 nm, about 10 nm and about 20 nm, as well as greater and smaller values.

Generally, the term “about” and the symbol “˜” as used herein, unless specified otherwise, is meant to encompass a variance or range of ±10%, the experimental or instrument error associated with obtaining the stated value, and preferably the larger of these.

As used herein, unless stated otherwise, room temperature is 25° C. And, standard ambient temperature and pressure is 25° C. and 1 atmosphere. Unless expressly stated otherwise all tests, test results, physical properties, and values that are temperature dependent, pressure dependent, or both, are provided at standard ambient temperature and pressure, this would include viscosities.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

Typically, a prior method employed in additive manufacturing is the use of an infrared laser and a galvanometer to scan the laser beam across the surface of a powder bed in welding process that melts and fuses the liquified powder to the lower layer or substrate. This approach has several limitations that determines the speed of the process and other deficiencies in the process. For example, a single laser beam is used to scan the surface and the build rate is limited by the maximum scanning speed of the galvanometers (7 m/sec). Manufactures strongly embrace IR technology, and typically believe that it is the only viable wavelength, thus they are working, but with limited success, to overcome this limitation by integrating two or more IR laser/galvanometers into a system, where the two can work in conjunction to build a single part or they can work independently to build parts in parallel. These efforts are aimed at improving the throughput of the additive manufacturing systems, but have been focused solely on IR and have been of limited success, not meeting the long felt need for improved additive manufacturing.

An example of another limitation in IR processing is the high intensity of the laser spot which forces the system into a keyhole welding mode that causes spatter and porosity in the part. For example, with a 500 mm F-theta lens the IR laser creates a spot size on the order of 40-50 μm for a diffraction limited infrared laser. If the laser beam is operating at 100 Watts optical power, then the intensity of the beam is greater than the intensity required to initiate the keyhole welding mode. The keyhole welding mode creates a plume of vaporized material that must be removed out of the path of the laser beam by a cross jet otherwise the laser beam is scattered and absorbed by the vaporized metal. In addition, because the keyhole mode of welding relies on creating a hole in the liquid metal surface that is maintained by the vapor pressure of the vaporized metal, the vaporized metal can be ejected from the keyhole. This material is referred to as spatter and results in molten materials being deposited elsewhere on the build plane that can lead to defects in the final part. While the manufactures of additive manufacturing systems have had some limited success in developing rapidly prototyping machines, they have failed to meet the long felt need, and achieve the requirements needed to produce commercial or actual parts in volume. To accomplish this a breakthrough in the method of patterning the parts, which prior to the present inventions the art has not achieved.

In general, a problem and failing with IR processing and systems is the requirement or need to fuse the powder in a keyhole welding mode. This can be typically because of the use of a single beam to process the powder. If the laser beam is operating at 100 Watts optical power, then the intensity of the beam is greater than the intensity required to initiate a keyhole welding mode. The keyhole welding mode creates a plume of vaporized material that must be removed out of the path of the laser beam by a cross jet otherwise the laser beam is scattered and absorbed by the vaporized metal. In addition, because the keyhole mode of welding relies on creating a hole in the liquid metal surface that is maintained by the vapor pressure of the vaporized metal, material such as the vaporized metal can be ejected from the keyhole. This material is referred to as spatter and results in molten materials being deposited elsewhere on the build plane that can lead to defects in the final part.

Recent work by Lawrence Livermore National Laboratories using an Optically Activated Light Valve (OALV) has been attempted to address these IR limitations. The OALV is a high-power spatial light modulator that is used to create a light pattern using high power lasers. While the pattern on the OALV is created with a blue LED or laser source from a projector, the output power from the four laser diode arrays are transmitted through the spatial light modulator and used to heat the image to the melting point and a Q-switched IR laser is required to initiate a keyhole weld. The IR lasers is used in the keyhole mode to initiate the weld, especially when fusing copper or aluminum materials. This keyhole weld process can create spatter and porosity in the part as well as high surface roughness, and is generally required for these materials. This keyhole weld process typically creates spatter, porosity in the part, as well as high surface roughness. Thus, the OALV systems as do typical IR systems does not eliminate the adverse effects of keyhole initiation of the building process. While it would be better to completely avoid the keyhole welding step, the art has failed to overcome this problem and has not provided this solution. This failure has primarily occurred because at the IR wavelengths the absorption properties of many metals are so low that a high peak power laser is necessary to initiate the process. Since the OALV is only transparent in the IR region of the spectrum, it is not feasible to build, or use this type of system using a visible laser source as the high energy light source. The cost of the components in this system are very high especially the OALV which is a custom component.

Prior metal based additive manufacturing machines are very limited in that they are either based on a binder being sprayed into a powder bed followed by a consolidation step at high temperatures, or a high-power single mode laser beam scanned over the powder bed by a galvanometer system at high speeds. Both of these systems have significant fallings that the art has been unable to overcome. The first system is capable of high-volume manufacturing of parts with loose tolerances due to the shrinkage of the parts during the consolidation process. The second process is limited in build speed by the scan speeds of the galvanometer limiting the maximum power level laser that can be used and consequently, the build rate. Builders of scanning based additive manufacturing systems have worked to overcome this limitation by building machines with multiple scan heads and laser systems, which has not provided an adequate solution to these problems. This does indeed increase the throughput, but the scaling law is linear, in other words a system with two laser scanners can only build twice as many parts as a system with one scanner or build a single part twice as fast. Thus, there is a need for a high throughput, laser-based metal additive manufacturing system that does not suffer from the limitations of the currently available systems.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

There has been a long-standing and unfulfilled need for, among other things, assemblies and systems to combine multiple laser beam sources into a single or number of laser beams, while maintaining and enhancing desired beam qualities, such as brightness and power. The present inventions, among other things, solve these needs by providing the articles of manufacture, devices and processes taught, and disclosed herein.

An embodiment of the present invention is an additive manufacturing system based on a 1-D or 2-D array of laser beams capable of directly fusing the powder in a parallel fashion with a step and repeat capability using a precision gantry system (FIG. 1, 2, 3). The speed can be increased by adding a 1-D or 2-D secondary laser beam to pre-heat and control cool down (FIG. 4). This secondary laser can also be an addressable array of laser beams to provide a preheat pattern consistent with the pattern being built.

Another element of an embodiment of the invention is the use of a real time temperature monitoring camera such as a thermal imaging camera. The camera can be used to monitor in real time the temperature of the powder layer as it transitions from a solid to a liquid and the image on the camera can be correlated with the laser pattern being applied and the power level of the individual laser beams can be adjusted according to a predetermined requirement to provide the proper fusing and cooling of the printed part. This closed loop control of the temperature provided additional benefits, such as, to minimize the porosity of the part being manufactured as well as to optimize the surface roughness and to minimize the residual stress in the part.

In an embodiment of the present invention there is included a means to deposit the powder in real time in either direction during the printing process as well as to compact the powder bed to minimize the porosity of the powder bed. The main mechanism for melting and fusing the powder will be conduction mode welding versus the galvo scanned system where keyhole mode welding is employed. This approach minimizes the spatter and the requirements to protect the windows and optics of the manufactured parts.

In an embodiment the present invention includes a sealed enclosure for forming an oxygen free environment and a recirculation system for the gas continuously cleaning the gas mixture being used. The filtering of the gas mixture is necessary because of airborne powders and welding fumes if not removed from the environment can begin to impact the quality of the image and consequently the quality of the part being built.

In an embodiment the present invention includes a micro-processing system that performs the pre-build analysis, breaking the part into slices and determining the optimum build strategy. As each portion of the part's pattern is printed, the gantry system may move to the next adjacent part of the pattern, or it may be commanded to move to any arbitrary position if the build strategy calls for a random printing of the partial pattern to minimize the residual stresses of the part.

In an embodiment the present invention also would not need a weld monitor other than a simple visible camera for looking at the weld puddle as it propagates. Since there is no-keyhole welding mode, the weld puddle is very stable, even when welding copper and aluminum, something that is not possible with an IR laser source. An IR laser source has to rely on a weld monitor such as an Optical Coherent Tomography (OCT) scanner to get an accurate representation of the keyhole and how the part build is progressing with the instabilities of the keyhole mode. Since the conduction mode of welding the powder to the based material is a very stable welding mode, there is no spatter, the welded powder is very uniform in thickness and shape and the part density is 100% due to the lack of vaporization of the material during the welding process.

Thus, there is provided an additive manufacturing system, process and laser system have one or more of the above features. There is further provided a laser system an additive manufacturing system, process and laser system having one or more of the above features in combination with the following laser systems and methods.

Thus, there is provided a laser system for performing laser operations, the system having: a plurality of laser diode assemblies; each laser diode assembly having a plurality of laser diodes capable of producing an individual blue laser beam along a laser beam path; a means for spatially combining the individual blue laser beams to make a combined laser beam having a single spot in the far-field that is capable of being coupled into an optical fiber for delivery to a target material; and, the means for spatially combining the individual blue laser beams on the laser beam path and in optical association with each laser diode.

Further there is provided the methods and systems having one or more of the following features: having at least three laser diode assemblies; and each laser diode assembly having at least 1 laser diode; wherein the laser diode assemblies are capable of propagating laser beams having a total power of at least about 2 Watts, and a beam parameter property of less than 20 mm mrad; wherein the beam parameter property is less than 15 mm mrad; wherein the beam parameter property is less than 10 mm mrad; wherein the means for spatially combining produces a combined laser beam N times the power density of the individual laser beams; wherein N is the number of laser diodes in the laser diode assembly; wherein the means for spatially combining increases the power of the laser beam while preserving the brightness of the combined laser beam; whereby the combined laser beam has a power that is at least 50× the power of the individual laser beam and whereby a beam parameter product of the combined laser beam is no greater than N times a beam parameter product of an individual laser beam; whereby the beam parameter product of the combined laser beam is no greater than 1.5*N times the beam parameter product of the individual laser beam; whereby the beam parameter product of the combined laser beam is no greater than 1*N times the beam parameter product of the individual laser beam; wherein the means for spatially combining increases the power density of the composite laser beam while preserving the brightness of the individual laser beams; whereby the combined laser beam has a power density that is at least 100× the power of the individual laser beam and whereby a beam parameter product of the combined laser beam is no greater than 2*N times a beam parameter product of the individual laser beam; whereby the beam parameter product of the combined laser beam is no greater than 1.5*N times the beam parameter product of the individual laser beam; whereby the beam parameter product of the combined laser beam is no greater than 1*N times of the beam parameter product of the individual laser beam; wherein the optical fiber is solarization resistant; wherein the means for spatially combining has optical assemblies, selected from the group consisting of alignment plane parallel plates and wedges, to correct for at least one of position errors or pointing errors of a laser diode; wherein the means for spatially combining has a polarization beam combiner capable of increasing the effective brightness of the combined laser beams over the individual laser beams; wherein the laser diode assemblies define individual laser beam paths with space between each of the paths, whereby the individual laser beams have space between each beam; and wherein the means for spatially combining has a collimator for collimating the individual laser beams in a fast axis of the laser diodes, a periodic mirror for combining the collimated laser beams, wherein the periodic mirror is configured to reflect a first laser beam from a first diode in the laser diode assembly and transmits a second laser beam from a second diode in the laser diode assembly, whereby the space between the individual laser beams in the fast direction is filled; wherein the means for spatially combining has a patterned mirror on a glass substrate; wherein the glass substrate is of sufficient thickness to shift the vertical position of a laser beam from a laser diode to fill an empty space between the laser diodes; and, having a stepped heat sink.

Still further there is provided a laser system for providing a high brightness, high power laser beam, the system having: a plurality of laser diode assemblies; each laser diode assembly having a plurality of laser diodes capable of producing a blue laser beam having an initial brightness; a means for spatially combining the blue laser beams to make a combined laser beam having a final brightness and forming a single spot in the far-field that is capable of being coupled into an optical fiber; wherein each laser diode is locked by an external cavity to a different wavelength to substantially increase the brightness of the combined laser beam, whereby the final brightness of the combined laser beam is about the same as the initial brightness of the laser beam from a single laser diode.

Further there is provided the methods and systems having one or more of the following features: wherein each laser diode is locked to a single wavelength using an external cavity based on a grating and each of the laser diode assemblies are combined into a combined beam using a combining means selected from the group consisting of a narrowly spaced optical filter and a grating; wherein the Raman convertor is an optical fiber that has a pure fused silica core to create a higher brightness source and an outer core surrounded by either air or a low index polymer to contain the blue pump light; wherein the Raman convertor is used to pump a Raman convertor such as an optical fiber that has a GeO₂ doped central core with an outer core to create a higher brightness source and an outer core that is larger than the central core to contain the blue pump light; wherein the Raman convertor is an optical fiber that has a P₂O₅ doped core to create a higher brightness source and an outer core that is larger than the central core to contain the blue pump light; wherein the Raman convertor an optical fiber that has a graded index core to create a higher brightness source and an outer core that is larger than the central core to contain the blue pump light; wherein the Raman convertor is a graded index GeO₂ doped core and an outer step index core; wherein the Raman convertor is used to pump a Raman convertor fiber that is a graded index P₂O₅ doped core and an outer step index core; wherein the Raman convertor is used to pump a Raman convertor fiber that is a graded index GeO₂ doped core; wherein the Raman convertor is a graded index P₂O₅ doped core and an outer step index core; wherein the Raman convertor is a diamond to create a higher brightness laser source; wherein the Raman convertor is a KGW to create a higher brightness laser source; wherein the Raman convertor is a YVO₄ to create a higher brightness laser source; wherein the Raman convertor is a Ba(NO₃)₂ to create a higher brightness laser source; and, wherein the Raman convertor is a high pressure gas to create a higher brightness laser source.

Still further there is provided a laser system for performing laser operations, the system having: a plurality of laser diode assemblies; each laser diode assembly having a plurality of laser diodes capable of producing a blue laser beam along a laser beam path; a means for spatially combining the blue laser beams to make a combined laser beam having a single spot in the far-field that is capable of being optically coupled to a Raman convertor, to pump the Raman converter, to increase the brightness of the combined laser beam.

Additionally there is provided a method of providing a combined laser beam, the method having an array of Raman converted lasers to generate blue laser beams at individual different wavelengths and combine the laser beams to create a higher power source while preserving the spatial brightness of the original source.

Yet further there is provided a laser system for performing laser operations, the system having: a plurality of laser diode assemblies; each laser diode assembly having a plurality of laser diodes capable of producing a blue laser beam along a laser beam path; beam collimating and combining optics along the laser beam path, wherein a combined laser beam is capable of being provided; and an optical fiber for receiving the combined laser beam.

Moreover there is provided the methods and systems having one or more of the following features: wherein the optical fiber is in optical communication with a rare-earth doped fiber, whereby the combined laser beam is capable of pumping the rare-earth doped fiber to create a higher brightness laser source; and, wherein the optical fiber is in optical communication with an outer core of a brightness convertor, whereby the combined laser beam is capable of pumping the outer core of a brightness convertor to create a higher ratio of brightness enhancement.

Still further there is provided a Raman fiber having: dual cores, wherein one of the dual cores is a high brightness central core; and, a means to suppress a second order Raman signal in the high brightness central core selected from the group consisting of a filter, a fiber Bragg grating, a difference in V number for the first order and second order Raman signals, a difference in the round trip gain for the first order and second order Raman signals due to the fiber length or cavity mirrors and a difference in micro-bend losses.

In addition, there is provided a second harmonic generation system, the system having: a Raman convertor at a first wavelength to generate light in a non-linear crystal at half the wavelength of the first wavelength; and an externally resonant doubling crystal configured to prevent the half wavelength light from propagating through the optical fiber.

Moreover, there is provided the methods and systems having one or more of the following features: wherein the first wave length is about 460 nm; and the externally resonant doubling crystal is KTP; and, wherein the Raman convertor has a non-circular outer core structured to improve Raman conversion efficiency.

Further there is provided a third harmonic generation system, the system having: a Raman convertor at a first wavelength to generate light at a second lower wavelength than the first wavelength; and an externally resonant doubling crystal configured to prevent the lower wavelength light from propagating through the optical fiber.

Further there is provided a fourth harmonic generation system, the system having: a Raman convertor to generate light at 57.5 nm using an externally resonant doubling crystal configured to prevent the 57.5 nm wavelength light from propagating through the optical fiber.

Further there is provided a second harmonic generation system, the system having a rare-earth doped brightness convertor having Thulium that lases at 473 nm when pumped by an array of blue laser diodes at 450 nm, to generate light at half the wavelength of the source laser or 236.5 nm using an externally resonant doubling crystal but does not allow the short wavelength light to propagate through the optical fiber.

Further there is provided a third harmonic generation system, the system having a rare-earth doped brightness convertor, having Thulium that lases at 473 nm when pumped by an array of blue laser diodes at 450 nm to generate light at 118.25 nm using an externally resonant doubling crystal but does not allow the short wavelength light to propagate through the optical fiber.

Further there is provided a fourth harmonic generation system, the system having a rare-earth doped brightness convertor, having Thulium that lases at 473 nm when pumped by an array of blue laser diodes at 450 nm to generate light at 59.1 nm using an externally resonant doubling crystal but does not allow the short wavelength light to propagate through the optical fiber.

Still additionally there is provided a laser system for performing laser operations, the system having: at least three of laser diode assemblies; each of the at least laser diode assemblies has at least ten laser diodes, wherein each of the at least ten laser diodes is capable of producing a blue laser beam, having a power of at least about 2 Watts and a beam parameter product of less than 8 mm-mrad, along a laser beam path, wherein each laser beam path is essentially parallel, whereby a space is defined between the laser beams traveling along the laser beam paths; a means for spatially combining and preserving brightness of the blue laser beams positioned on all of the at least thirty laser beam paths, the means for spatially combining and preserving brightness having a collimating optic for a first axis of a laser beam, a vertical prism array for a second axis of the laser beam, and a telescope; whereby the means for spatially combining and preserving fills in the space between the laser beams with laser energy, thereby providing a combined laser beam at a power of at least about 600 Watts, and a beam parameter product of less than 44 mm-mrad.

Yet further there is provided an addressable array laser processing system, the addressable array laser processing system having: at least three laser systems of the type presently described; each of the at least three laser systems configured to couple each of their combined laser beams into a single optical fiber; whereby each of the at least the three combined laser beams being capable of being transmitted along its coupled optical fiber; the at least three optical fibers in optical association with a laser head; and a control system; wherein the control system has a program having a predetermined sequence for delivering each of the combined laser beams at a predetermined position on a target material.

Moreover there is provided the methods and systems for an addressable array having one or more of the following features: wherein a predetermined sequence for individually turning on and off the laser beams from the laser head, thereby imaging onto a bed of powder to melt and fuse the target material having a powder into a part; wherein the fibers in the laser head are configured in an arrangement selected from the group consisting of linear, non-linear, circular, rhomboid, square, triangular, and hexagonal; wherein the fibers in the laser head are configured in an arrangement selected from the group consisting of 2×5, 5×2, 4×5, at least 5× at least 5, 10×5, 5×10 and 3×4; wherein the target material has a powder bed; and, having: an x-y motion system, capable of transporting the laser head across a powder bed, thereby melting and fusing the powder bed; and a powder delivery system that may move behind the laser source to provide a fresh powder layer behind the fused layer; having: a z-motion system, capable of transporting the laser head to increment and decrement a height of the laser head above a surface of the powder bed; having: a bi-directional powder placement device capable of placing powder directly behind the delivered laser beam as it travels in the positive x direction or the negative x direction; having a powder feed system that is coaxial with a plurality of laser beam paths; having a gravity feed powder system; having a powder feed system, wherein the powder is entrained in an inert gas flow; having a powder feed system that is transverse to N laser beams where N≥1 and the powder is placed by gravity ahead of the laser beams; and having a powder feed system that is transverse to N laser beams where N≥1 and the powder is entrained in an inert gas flow which intersects the laser beams.

Yet still further there is provided a method of providing a combined blue laser beam having high brightness, the method having: operating a plurality of Raman converted lasers to provide a plurality of individual blue laser beams and combining the individual blue laser beams to create a higher power source while preserving the spatial brightness of the original source; wherein the individual laser beams of the plurality have different wavelengths.

Moreover there is provided a method of laser processing a target material, the method having an addressable array laser processing system having at least three laser systems of the type of the presently described systems to generate three individual combined laser beams into three individual optical fibers; transmitting each combined laser beams along its optical fiber to a laser head; and directing the three individual combined laser beams from the laser head in a predetermined sequence at a predetermined position on a target material.

### BRIEF DESCRIPTION OF THE DRAWINGS

FIG. 1 is a perspective view of an embodiment of a 3-D printer based on array of fibers in accordance with the present inventions.

FIG. 2A is perspective view an embodiment of a fiber based printer head in accordance with the present inventions.

FIG. 2B is a perspective view of the fiber based printer head of FIG. 2A from a different perspective.

FIG. 3 is a schematic graphic depiction of an embodiment of an optical bundle, and beam paths, in accordance with the present inventions.

FIG. 4A is a perspective view of an embodiment of a 1-D bundle connector output for a fiber bundle for a 1-D patterning system, in accordance with the present inventions.

FIG. 4B is a perspective view of an embodiment of a fiber combiner accordance with the present inventions.

FIG. 5A is a schematic of an embodiment of a 3-D printer head with secondary laser heat source and a primary 1-D patterning system in accordance with the present inventions.

FIG. 5B is a perspective view of an embodiment of an overlapping image of a secondary laser pattern and a multi-spot primary image in accordance with the present inventions.

FIG. 6A is a schematic of an embodiment of a 3-D printer head with secondary laser heat source and a primary 1-D patterning system in accordance with the present inventions.

FIG. 6B is a perspective view of an embodiment of an overlapping image of a secondary laser pattern and a multi-spot primary image in accordance with the present inventions.

FIG. 7A is a schematic of an embodiment of a printer head having a 1-D primary multi-spot image and a secondary heating image based on laser diode array for the primary image in accordance with the present inventions.

FIG. 7B is a perspective view of an embodiment of an overlapping image of a secondary laser pattern and a multi-spot primary image in accordance with the present inventions.

FIGS. 8A-8F are plan views of various embodiments of fiber bundle image configurations (e.g., laser beams forming a laser beam pattern, or laser pattern) on powder bed in accordance with the present inventions, with the arrows showing the direction of movement of the pattern on the bed.

FIGS. 9A-9F are plan views of various embodiments of fiber bundle image configurations (e.g., laser beams forming a laser beam pattern, or laser pattern) on a powder bed, where the primary laser beams image are associated with the secondary laser beam image, in accordance with the present inventions, with the arrows showing the direction of movement of both patterns on the bed. (The primary image spots are show as solid spots and the secondary image spot is shown as an outline spots.)

FIGS. 10A-10F are plan views of various embodiments of fiber bundle image configurations (e.g., laser beams forming a laser beam pattern, or laser pattern) on powder bed, where the primary laser beams image are associated with the secondary laser beam image, and the second laser beams have different timing features creating different shaped secondary images, in accordance with the present inventions, with the arrows showing the direction of movement of both patterns on the bed. (The primary image spots are show as solid spots and the secondary image spots are shown as outline spots.)

FIG. 11. is a schematic plan view of mapping of image on powder bed onto a thermal imaging camera in accordance with the present inventions.

FIG. 12 is a schematic of an embodiment of a control system and a closed loop control process in accordance with the present inventions.

FIG. 13 is an image and spectrum of a blue Raman converted laser beam in accordance with the present inventions.

### DESCRIPTION OF THE PREFERRED EMBODIMENTS

The present invention relates to laser processing of materials and in particular laser building of materials including laser additive manufacturing processes using laser beams having wavelengths from about 350 nm to 700 nm.

1-D Patterning System

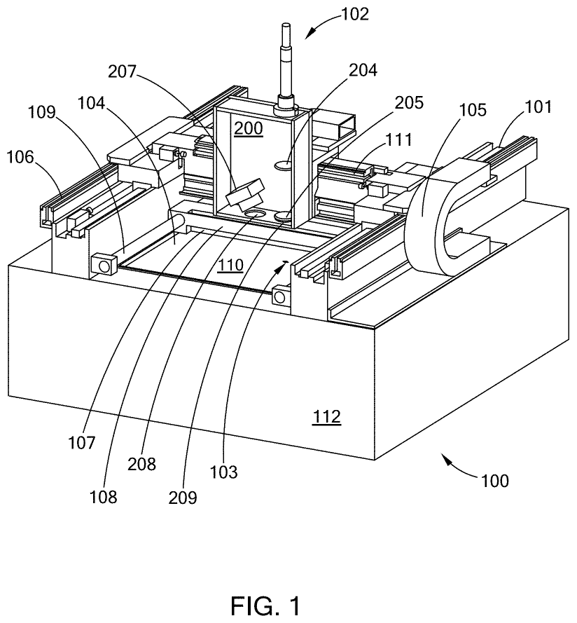

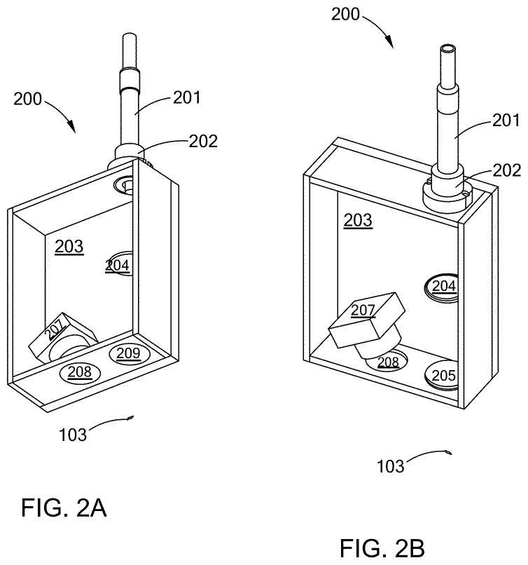

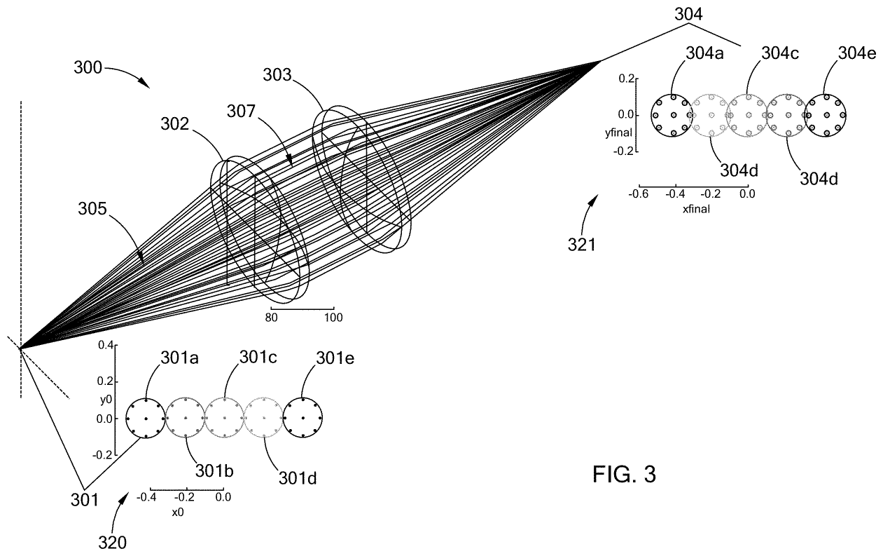

FIG. 1 is a perspective view of a 3-D (three-dimensional) additive manufacturing device or printer device 100. The printer device 100 has a fiber configuration coming into the print head that is in a 1-D (one-dimensional) fiber configuration. This 1-D system can have the incoming fibers arranged in a linear manner, such as for example, as shown in FIGS. 2A and 2B, and having ray paths, images and optics as shown, for example, in FIG. 3.

Thus, FIGS. 1-3 are an example of 3-D printer that uses a 1-D patterning system, where the 1-D refers to the configuration for the fiber bundle that provide and launch the laser beams used to build a 3-D object.

Turning first to FIG. 1, but in the context of FIGS. 2A, 2B and 3, the system 100 consists of an x-y gantry system 101, which moves the print head 200 in the x and y direction. The gantry system sits on a base 112, which may be made of granite, or metal, or preferably other materials that are heavy, stable and both. The base may be vibration isolated from the rest of the system using rubber or air supports under it to prevent the communication of vibrations from the base to the powder bed 110 and the printer head 200. The entire system 100 can be enclosed in an air-tight environment (not shown in the figure) to provide an inert atmosphere for the processing of the powder. The inert atmosphere may be Argon, Nitrogen, Helium or any other inert gas other than oxygen. The inert atmosphere by be at reduced pressure, atmospheric pressure, or increased pressure, and many be through flowing (in flow and outflow ports), in flowing (i.e., replenishment gas flowed in, but no outflow) or non-flowing (input and output closed after filling with inert gas). The preferred embodiment is Argon as well as Argon-CO₂ mixtures to promote flowing of the molten powder by breaking down their surface tension. The gantry stage carries the printer head 200 and the fiber array bundle is delivered by a QBH style connector 102 to the printer head 200. Just below the printer head is the powder bed 110, where the image transmitted by the fiber bundle or array is reimaged 103 on the powder bed 110. The powder is spread by a bi-directional powder spreader 108, which rides on a pair of linear rails 109 for precision movement. The powder spreader can be moved by either the y motion of the Y translation stage 106 of gantry system 101, or by a separate motor integrated into the powder spreader assembly. The powder is loaded into the powder spreader at the edge of the based 112 both at the front and the back, and the powder is delivered to the powder bed by a gravity feed. The powder spreader includes a roller 107 the rotates in the opposite direction of the motion to spread and compress the powder bed. By compressing the powder bed, the porosity of the final part can be minimized. The power and sensor readouts are routed through the flexible cable tray 105 on the side of the gantry as the gantry moves in the y direction.

The gantry system 101 has Y translation stage 106 for movement of print head 220 in the y direction; and has Z translations stage 111 for movement of print head 220 in the x direction. The system 100 has a powder bed elevator 104 (for moving the part down as it is built allowing the next layer to be deposited on the part).

In a preferred embodiment of the printer head 200 is shown in FIGS. 2A and 2B. FIGS. 2A and 2B are perspective views of the same embodiment but from deferent perspectives, it being understood that typically the printing head would be covered, or have a front plate, which is not shown in the figures. The fiber bundle has 2, 3, 4, 5, 6, 2-10, and combinations of these, as well as larger numbers arranged in a line, preferably a straight line. The fiber bundle is delivered via the QBH connector 201. The QBH connector 201 is held in place by a collet 202 which is mounted to the case 203 of the print head 200. The optical system consists of a collimating optic 204 and a focusing optic 205. These two optics may be replaced by a single imagine optic. The laser beams are launched from the face of the fibers 210 and the laser beams travels along a laser beam path to lens 204, lens 205 and then out window 209 to form an image 103. In addition to the optical system, the printer head 200 may also house a thermal imaging or pyrometer camera 207 for monitoring the temperature of the melt pool, through opening or window 208 for the multi-spot image 103, on the powder bed.

Turning to FIG. 3 there is shown a schematic of an embodiment of a of a 1-D optical system 300 and the ray trace of its lasers beams path. This 1-D optical system, can for example, be used in print head 200. The fiber bundle 301 has five optical fibers 301a, 301b, 301c, 301d, 301e, arranged in a straight line, and provide output laser beams along beam path having ray paths 305, which output is collimated by the lens 302, which may be a plano-convex lens, a plano-convex aspheric lens, a pair of lenses, a triplet of lenses or similar type of optics. The collimated beams from the array bundle having ray paths 307 is then focused to an image 304 having a series of spots 304a, 304b, 304c, 304d, 304e by the focusing lens 303 which may be a plano-convex lens, a plano-convex aspheric lens, a pair of lenses, a triplet of lenses or similar type of optics. The size of the fibers is shown by scale 320 and the size of the image and spots is shown by scale 321. The curved surfaces of the plano-convex and plano-aspheric lenses face each other to minimize the spherical aberrations of the system. The ray trace shown in FIG. 3 is for two fused silica plano-aspheric lenses. The spot is at the focal plane or Fourier Transform plane and due to the small aberrations in the system, there is a slight spreading of the image resulting in an overlap of the individual fiber images, i.e., the spots 304a, 304b, 304c, 304d, 304e, which make up image 304. The system may also use a single imaging lens, here the launch face of the fiber source 301 would be placed at least 2f away from the imaging optic and the image plane would be at least 2f away from the same optic. This approach would require a substantially larger lens than the preferred embodiment of using a collimating lens and a focusing lens to reimage the fiber bundle. The thermal imaging or pyrometer camera preferably monitors the temperature of the melt pool, for each individual spot in the multi-spot image, on the powder bed.

In embodiments of the 1-D patterning system, the 1-D line of emitters, e.g. fibers faces, may be 2, 3, 4, . . . n, all depending on the physical size of the fibers and the QBH connector. In an embodiment there is a single fiber. In an embodiment, 2 to 15, 2 to 10, 5 to 50, 2 to 1,000, 5 to 500, 100 to 2,000, more than 10, more than 20, more than 50, and combinations and variations of these, and greater and smaller numbers of fibers are positioned for example, side by side. Thus, for example, 200 μm in diameter fibers, (having core diameters for example from about 10 to about 185 μm) could be used and their beams and the beams image reimaged onto the powder bed to provide the power to melt and fuse the powder to the base material.

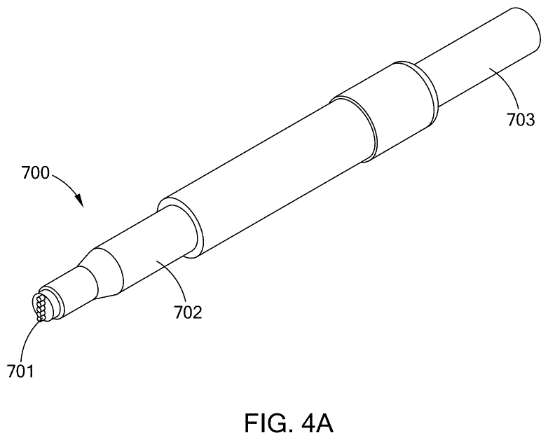

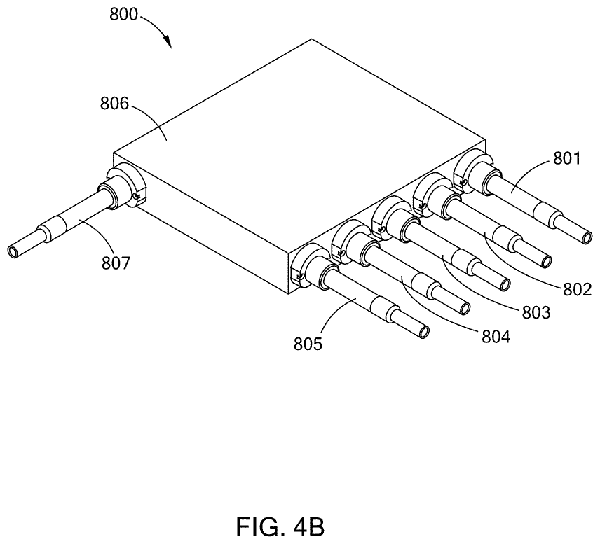

Turning to FIG. 4A there is shown a perspective view of an embodiment of a QBH style bundle connector output 700. This connector output 700 has five fibers 701 arranged in a straight line, to provide five emitters of laser beams and their images, e.g., circular spots. The connector output 700 has a mechanical QBH input 702 that houses the five fibers. This input 702, can be plugged into, for example, the printer head, or a combining assembly, of for example, the type shown in FIG. 4B. The connector output 700 has a protective covering 703 that covers the optical fibers and has a break sensor.

An example of an embodiment of a fiber bundle combiner is shown in FIG. 4B. The combiner 806 in this case is a free space combiner with the input fibers 801, 802, 803, 804, 805, begin collimated before being combined and refocused into the output fiber bundle 807, which is then transmitted by the optical fibers to, for example an output connector, a printer head. The fiber bundle receives the power from each of the individual fibers, 801, 802, 803, 804, 805 and is reimaged onto the powder bed. The power from each fiber can be about 2 Watts (W), 10 W, 100 W, about 150 W, about 500 W, about 1 kW, about 2 kW, from bout 1 W to about 2 kW, from about 2 W to about 150 W, from about 250 W to about 1 kW, or multi-kWatts, and combinations and variations of theses, depending on, for example, how fast the gantry system can scan and the size of the fiber bundle image.

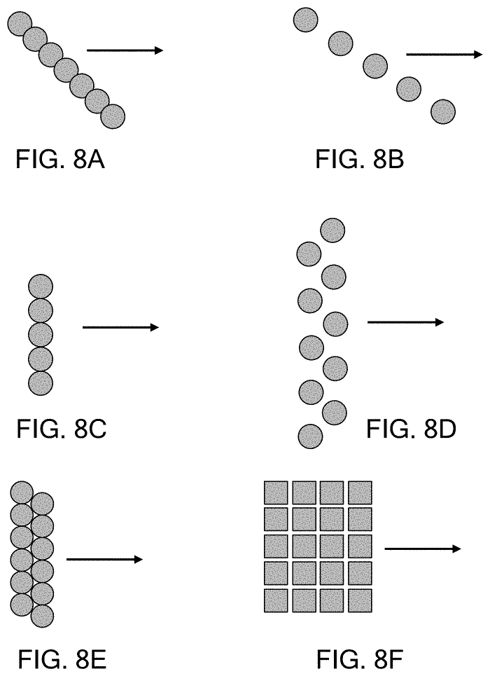

Examples of various embodiments of 1-D laser image patterns (e.g., multi-spot images) that can be generated by 1-D fiber bundle configurations and printer heads, are shown in FIGS. 8A, 8B, 8C, 8D, 8E, 8F. The direction of movement of the pattern on the powder bed is shown by the arrows. These laser patterns can be used with any of the embodiments of additivities manufacturing systems, printer heads and methods in accordance with the present inventions.

The spots in a multi-spot image can be circular, elliptical, square, rectangle, and other shapes; they can be conjoined, adjacent, overlapping, partially overlapping; they can be linear, a straight line, a curved line, staggered, in a pattern forming a larger area, e.g., square or rectangle; and, combinations and variations of these and other configurations and arrangements. These laser patterns can be used with any of the embodiments of additivities manufacturing systems, printer heads and methods in accordance with the present inventions.

The part is printed by scanning the 1-D image of the fiber bundle across the powder bed. The 1-D image of high-power fiber outputs is swept in the y-axis by the gantry system and is stepped over in the x-axis to repeat the pattern. The step over can be adjacent to the track just printer, or it could be randomly varied depending on the stress patterns desired in the final part. After printing, the powder bed elevator, which is located below the powder bed, drops the powder bed a predetermined amount, (e.g., about 40 μm, about 50 μm, about 60 μm, from about 35 μm to about 65 μm, and combinations of these and larger and smaller distances), the powder spreader spreads an even layer of powdered metal, the roller compresses the powder bed to reduce the porosity of the powder. After the powder bed has been prepared for the next layer, the next layers is printed with the image of the 1-D fiber bundle scanned across its surface.

The fiber system can also be replaced by individual laser diodes, however this is not the preferred embodiment because of the size of the printhead and the complex electronics required to drive individual laser diodes. The individual laser diodes could be part of an addressable laser diode array bar, in which case the individual laser diodes are all part of a contiguous bar assembly, with individual current drive capabilities. This is a good alternative to the fiber approach with limited power per emitter.

1-D Patterning System with Secondary Laser

In an embodiment, additional or second laser beam is added to the print head to provide a means to pre-heat, control the cooling and control the temperature of the printed image. The secondary laser beam can also be referred to as a heating beam; while the primary laser beams that are used to melt and fuse the powder to form an object can be referred to as the build laser and build laser beam.

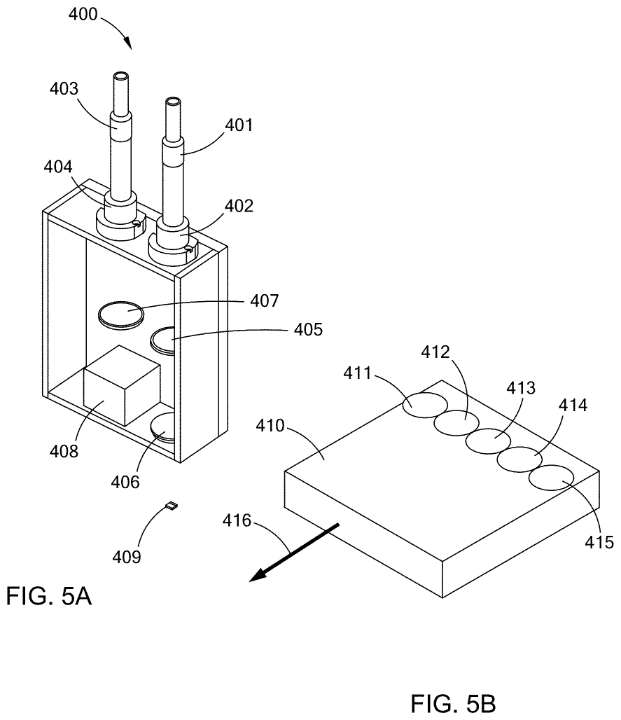

An embodiment of a print head having primary and secondary laser beams is shown in FIG. 5A, the fiber bundle that provides the primary laser beams and creates the primary image 409 (which can be a multi-spot image) on the powder bed is delivered by the QBH connector 401 and is mounted on the print head 400 by the collet 402. The optical system for the beam path and beam delivery for the primary image 409 consists of a lens 405 to collimate the output of the fiber bundle. The collimated output is then focused onto the power bed as primary 409 by the focusing lens 406. This is optical system is similar to the previous description where the lenses may be plano-convex, plano-convex—aspheres, doublets or triplets. A second laser beam is introduced into the print head 400 through an optical fiber delivered by QBH connector 403, which is mounted to the print head with collet 404. A lens 407 is used to collimate the output of the fiber. The lens 407 may be a plano-convex, plano-convex asphere, a doublet or a triplet. At high power levels the doublet or the triplet would have to be air spaced since most cements would not survive the high-power levels. The collimated beam is then transformed and focused to the powder bed by a lens or micro-lens system 408, which shapes the beam into a secondary image and redirects it to overlap with the primary image 409. An embodiment of these overlapping images is shown in FIG. 5B. The over lapping images 450 may be a primary multi-spot image 451 having primary spots 411, 412, 413, 414, 415, which spots are propagated from the primary fibers in the primary fiber bundle. The primary spots are combined with a secondary image 410 of the secondary transformed laser beam. Preferrably the secondary image heats a volume of powder 420. In this embodiment, the secondary laser beam is positioned to deposit the majority of its energy just in front of the 1-D pattern 451 being translated in the “y” direction as shown by arrow 416. Both the primary 451 and secondary 410 patterns are moving at the same rate and in the same direction 416. This secondary beam pattern, pre-heats the powder, assists the image of the fiber bundle to melt the powder and fuse it to the substrate, and provides some heat after the fusing to anneal the material thereby reducing the internal stresses in the part being printed. The rest of the system functions as described in the previous section, where a thermal imaging camera or a pyrometer array is integrated in the system to provide feedback to the laser systems to maintain the powder just ahead of the primary fiber bundle image 451 at a predetermined temperature, preferably just below the melting point of the powder. During the fusing process, the feedback signal from the thermal imaging camera or pyrometer array is used to control the power of the secondary laser, the individual lasers in the fiber bundle that create image 451, and both, to create a predetermined powder temperature within the image of the fiber bundle. The predetermined powder temperatures used in the system will be determined empirically with the system initially and be used as a guideline for all builds to minimize surface roughness, part porosity and part size. The secondary laser source may be 50 Watts, 100 Watts, 150 Watts, 500 Watts, 1,000 Watts, from about 50 Watts to about 2 kW, from about 250 Watts to about 1 kW, and multi-kWatts, and all values within these ranges, depending on, for example, the scanning speed of the print head and the area of the fiber array pattern in use.

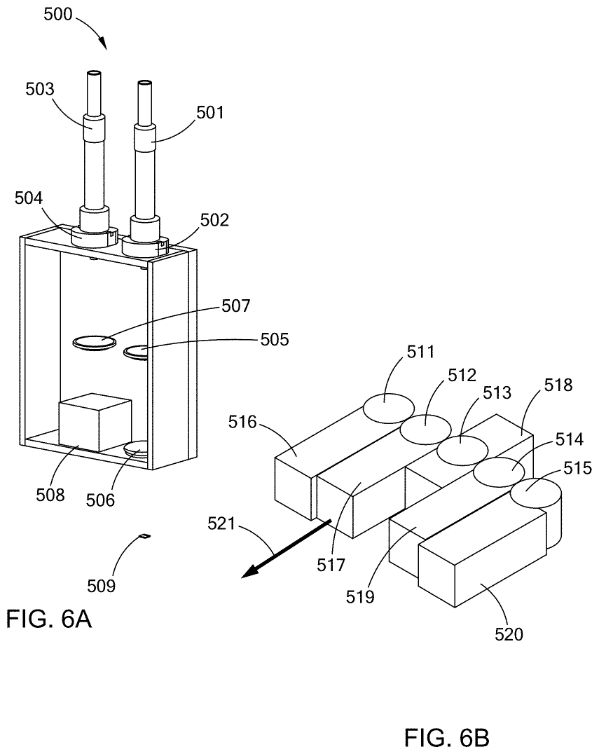

Turning to FIGS. 6A and 6B there is shown perspective view of a laser head 500 that provides a combined image 509 of a secondary 552 and primary image 551, where both the secondary fiber bundle laser source provides an addressable heat pattern on the powder bed. FIG. 6 illustrates the use of a secondary fiber bundle, where the fiber bundle is attached by connector 503 is attached to the printer head 500 with the collet 504. The primary fiber bundle is attached by connector 501 and collet 502 to printer head 500, and has collimating lens 505 and fourier transform focusing lens 506. The lens 507 collimates the fiber bundle and the beam transformation system 508 creates n images of the secondary fiber bundle that can be individually controlled to form the image 552, which in this embodiment has images 516, 517, 518, 519, 520 that correspond to a volume of the powder in the powder bed that is heated. By controlling the time that each secondary laser source is turned on and off, it is possible to change the pre-heat and the cool down characteristics of each corresponding volume to the images 516-520. In the embodiment of FIG. 5B, the two outer fibers which provide outer secondary images 516, 520, are turned on and off at the same time to pre-heat the outer edge of the pattern. The two inner fibers, which provide images 517, 519, are then turned on slightly later to allow the heat buildup from the outer fibers to soak into the inner regions because less energy is required in the inner regions due to the heating of the two outer regions. The central secondary fiber image 518 requires even less energy so the source is turned on later, at a lower power level and turned off late to provide heat to anneal either the one region corresponding to the laser spot 513 or the entire region corresponding to laser spots 511-515, which form primary multi-spot image 551, depending on thermal conductivity of the material and the design of the part. Each secondary fiber may deliver 30 Watts, 100 Watts, 150 Watts, from about 50 Watts to about 2 kW, from about 250 Watts to about 1 kW and multi-kWatts of power and all values within these ranges, depending on, for example, the scanning speed of the print head and the size of the heated pattern.

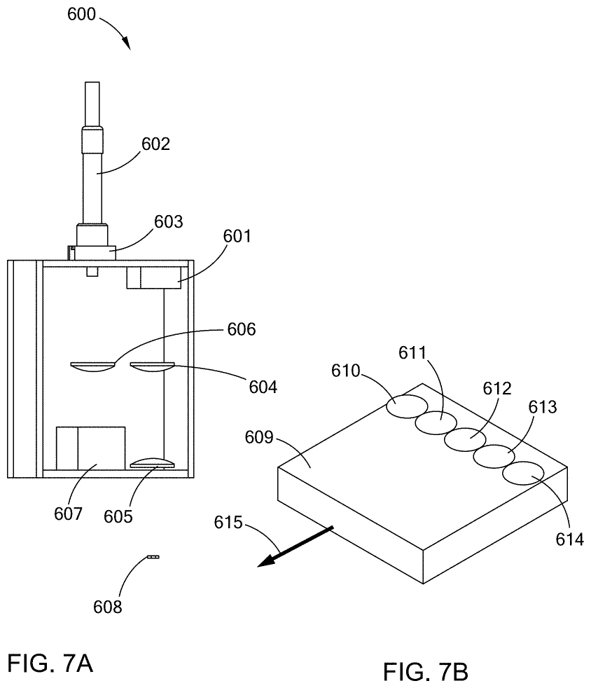

Turning to FIGS. 7A and 7B there is shown perspective views of a laser printing head 600 that provides a primary multi-spot laser beam image 608 having spots 610, 611, 612, 613, 614 and a secondary laser beam image 609 that overlaps image 608 and that heats a volume 651 of the power. The primary laser source is diode array 601 (which can provide a 1-D pattern or a 2-D pattern) the primary laser beam path leaves the array 601 and enters a first beam transforming optic 604 and then a second beam transforming optic 605 to from image 608, which is an 1-D pattern, on the surface of the powder bed. The secondary laser has a fiber or fiber bundle that is connected to the printer head 600 by connector 603 and collet 603. The secondary laser beam path travels from the fiber or fiber bundle to a collimating lens 606 and then to a beam transformation optic 607 to shape and overlap the secondary laser beam image 609 with the primary laser beam image 608. The direction of travel of the laser beams, and their respective images with respect to the powder bed is shown by arrow 615.

In the embodiment of FIGS. 7A and 7B, an addressable laser diode array source produces the addressable heat pattern on the powder bed. Each emitter from the addressable laser diode array source 601, may be 3 Watts, 10 Watts or higher as limited by the diode array technology. By itself the individual power levels of the laser diodes are insufficient to melt many metal materials, so a secondary heat source or laser source which is provided by a fiber or fiber bundle in connector 602 is a requirement of any design using an addressable laser diode array. Either a heated powder bed or a secondary laser source can be used. Here the secondary laser source is used to provide an image 609 to pre-heat a volume 651 of the powder to just below the melting point, and the image of the laser diode array 608 is used to melt and fuse the powder to the material below it. The secondary laser source may be a single fiber, a fiber bundle, which are connect to printer head 600 by connector 602 and collet 603, or the secondary laser source can be another laser diode array that is collimated and reimaged to form a single image 609 or a sequence of images, such as shown in the embodiment of FIG. 6A. The preferred embodiment for the laser diode array is a blue laser diode source because of the enhanced absorption over the IR laser diode sources. The 1-D patterns that may be used in a direct laser diode array source are most likely the embodiment of FIGS. 8B and 8D where spacing between the diodes must be considered in any design, however an optic that transforms the image may be used to create any of the images of the embodiments of FIGS. 8A-8A.

One or more or all of the primary laser beams forming the primary laser beam pattern can be completely within the area of secondary laser pattern, partially within the area of the secondary laser pattern, completely outside of the area of the second laser beam pattern, and combinations and variation of these. In embodiments the primary and secondary laser beam patterns can move at the same speed in the same direction, at different speeds in the same direction (e.g., primary faster, or secondary faster) and in different directions, at the same or different speeds) and combination and variation of these. The primary and secondary laser beams may also be moved in independent predetermined patterns to build specific types of items or provide specific types of features to a built item.

The primary laser beam pattern can have one, two, three, four, or more, and tens or more, of laser beams. The secondary laser beam pattern can be a single beam, or can be multiple laser beams, or multiple overlapping laser beams, and combinations and variations of these.

The primary laser beam cross sections can be circular, elliptical or square or other shapes. The primary laser beam patterns can be arranged linearly, in a square configuration, in a rectangular configuration, in a circular configuration, in an elliptical configuration, in a parabolic configuration (either convex or concave with respect to the motion of the pattern), in an arch (either convex or concave with respect to the motion of the pattern), arrow or “V” configuration, diamond configuration, as well as, other geometric patterns and configurations and combinations and variations of these.

In an embodiment the secondary pattern can be from a high intensity visible, UV or IR lamp imaged through a spatial light modulator, or a high power laser imaged through a spatial light modulator or an array of lasers ranging from 1 to N sources arranged in a 1-D or 2-D pattern. The array of secondary lasers may be an array of laser diodes or an array of fibers connected to individual laser systems.

2-D Patterning System

A preferred embodiment is to use two-dimensional (2-D) fiber bundles or laser arrays as the heat, or energy, source when printing a metal part. An example of some 2-D fiber bundles, and the laser patterns or multi-spot images they produce are shown in the embodiments of FIG. 8D-8F. FIG. 8F is an image of square spots, formed from an array of square or rectangular optical fibers, or other optics that shaped the beams to provide these spots. In an embodiment, the change from a 1-D patterning system and an embodiment of a 2-D patterning system is the addition of more rows of fibers in the printer head (comparing FIG. 8C with 8E) and the ability to print faster because of the larger addressable area. These 2-D sources may have individual laser power levels of 3 Watts, 10 Watts, 20 Watts, 100 Watts, 150 Watts, from about 50 Watts to about 2 kW, from about 250 Watts to about 1 kW and multi-kWatts depending on the scanning velocity of the printer system and the size of the pattern printed.

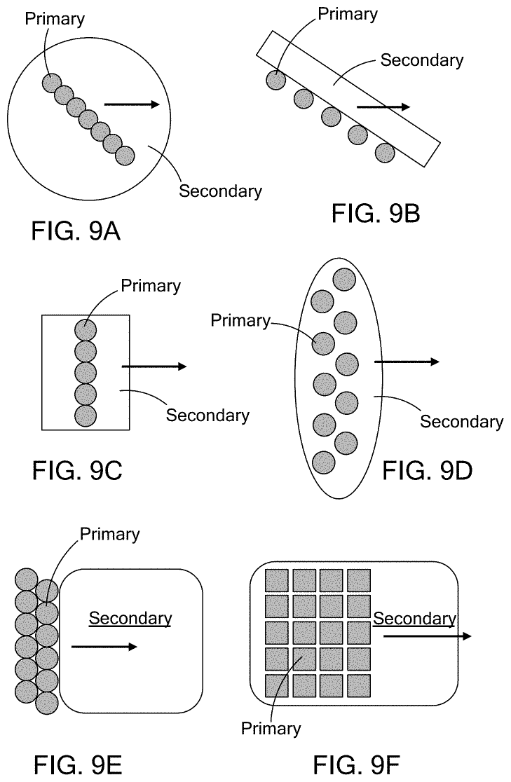

The 2-D patterning system can also be combined with a single secondary laser source, an array of secondary laser sources or a bundle of secondary laser sources, and combinations and variations of these, to provide energy to pre-heat or controlled cool down of the pattern being printed. In embodiments high power images on the powder bed can be overlaid with a single secondary laser. Turning to FIGS. 9A to 9F there are shown plan views of embodiments of composite images of primary images and secondary images. The direction of movement of both primary and secondary beam patterns is shown by the arrow in each figure.

FIG. 9A shows an embodiment of a straight line 1-D multi-spot primary image at an angle to the movement of direction and completely with in a circular secondary image.

FIG. 9B shows an embodiment of a primary image that is a tilted array 1-D image with dead space between each spot being compensated by the tilt angle of the spots, and a single secondary image provided by a secondary laser source for pre-heating the powder prior to fusing. In this embodiment the secondary image is adjacent to, but does not overlap the primary beam pattern.

FIG. 9C shows an embodiment of a simple linear array primary image overlapped with a rectangular secondary laser image to provide both pre-heat and post fusing energy for controlling the temperature through the build sequence.

FIG. 9D shows an embodiment of a spaced 2-D array pattern overlapped by a single elliptical secondary laser spot again, to provide the energy needed for a given scan speed to bring the temperature of the powder to just below the melt temperature and to provide a means for annealing the material after welding.

FIG. 9E shows an embodiment of a 2-D primary image from a dense fiber array again with a single pre-heat beam image from a secondary laser source, that is adjacent to and forward of the primary image.

FIG. 9F shows an embodiment of a 2-D primary image from a dense array of square fibers that are adjacent. In an embodiment the squares are overlapped to minimize processing gaps. This dense array pattern is overlapped by a secondary laser source with the intent of pre-heating the powder, providing additional energy during the melt and bonding process and finally provide some temperature control after the melt and fusing step.

These secondary laser sources for the secondary image patterns of the embodiments in FIGS. 9A to 9F, and in other embodiments of the secondary laser patterns and images, could be about 2 Watts, about 3 Watts, about 10 Watts, about 20 Watts, about 50 Watts, about 100 Watts, about 150 Watts, from about 50 Watts to about 2 kW, from about 10 Watts to about 200 W, from about 50 Watts to about 500 W, from about 250 Watts to about 1 kW and multi-kWatts, depending on, for example, the scanning speed of the print head, the power of the primary laser beam and the size of the area being heated.

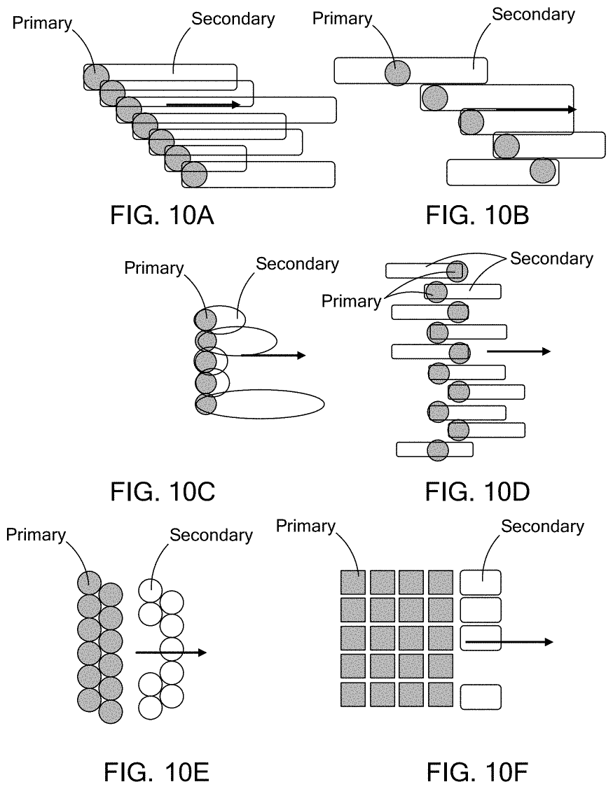

Combining the fiber bundled primary laser source with a fiber bundled secondary source makes it feasible to change the pre-heat and cool down temperature cycles during the building of an object. Thus, pre-heat and cool down processing cycles can be changed, e.g., adapted, to the conditions of the build item as it is being built. In this manner information about a property of the built item, such as temperature, roughness, density, spectrum of light emitted or reflected, is used to change and adjust the secondary fiber laser beam properties, such as time on and power, and thus adjust the secondary image “on the fly” with respect to the primary image, the building of the item and both. FIGS. 10A-10F, show different configurations and timing effects possible when overlapping the addressable laser image pattern with an addressable secondary pre-heat pattern. A further advantage of a laser pre-heat is the elimination of having to heat the entire bed or chamber which takes a considerably more amount of energy.

Temperature Control System

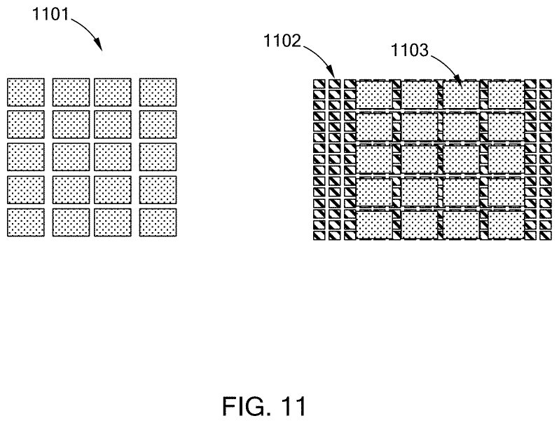

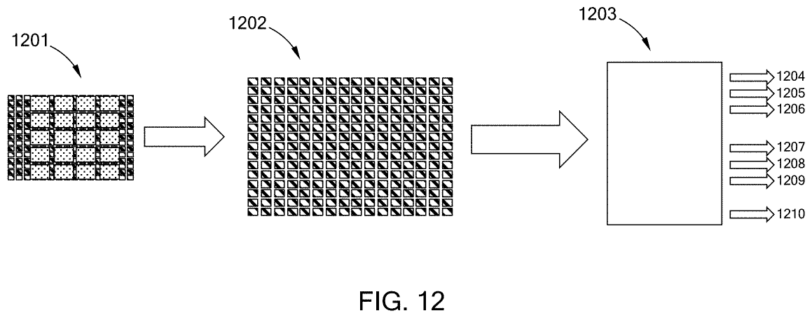

Prior additive manufacturing systems, before the present inventions, operated in an open-loop fashion which did not allow the print quality to be controlled accurately. This was a significant failing of these prior systems, and one that embodiments of the present inventions address and improve upon. In an embodiment of the present inventions, a feedback loop is used to precisely control the temperature in each of the 1-D or 2-D patterns as well as the secondary laser pattern and the powder bed where these patterns are delivered. This feed-back loop provides many advantages, including for example, the parts that are built will have lower porosity, lower defects and better surface roughness than an open loop system can achieve. Because of the relatively low speed that the gantry system will be traveling compared to the galvanometer based systems it is feasible to measure the temperature of the powder bed at every point in the print pattern and change the power setting of the laser addressing that region of the print pattern to a more optimum setting in real time, during the printing process, e.g., “on the fly”, adjustment of the printing process based upon temperature profile of the item as it is being built. In an embodiment the temperature profile of the bed is monitored and controlled on a laser spot by laser spot basis, to then adjust the power, timing and both of the laser spots to control the building process of the item. FIG. 11 illustrates how the image 1101 of the fiber bundle can be reimaged 1103 onto the camera sensor array 1102. The software for reading the sensor array can then recognize the heated regions and provide the average temperature of each region. If the laser sources are all the same power, then the central pixels will read a much higher temperature than the out pixels, and the power to the inner sources can be decreased until a uniform temperature profile is achieved. This keeps the powder melting and fusing within an optimum temperature range. This applies not only to the 2-D fiber bundle images, but also to the 1-D fiber bundle images. Once the temperature of a region is measured, as shown in FIG. 12, a sequence of command signals is calculated 1204-1210 that either increase or decrease the power to each region until a uniform, or predetermined optimum temperature profile is achieved. Thus, an image 1201 of the array or fiber bundle on the powder bed is imaged onto a device to receive an analyze an image, e.g., sensors, camera, such as a FLIR camera. This provides a matrix 1202 of temperature profiles on a pixel by pixel basis. A processor, e.g., computer, microprocessor, interpolates and translates the temperature profiles from matrix 1202 with respect to the build program and adjust laser power to meet the build strategy, by sending out control signals 1204-1210 to the lasers associated with individual fibers or the images created by those lasers. In this manner a spot-by-spot on the fly adjustment of the laser beam and build profile is provided. Also, by providing a real time feedback signal to the laser sources, in the event that the powder does not properly melt, then it will be feasible to increase the power to that region to increase the chances of it melting properly. This would occur in regions where there is a large variability in the diameter of the powders, with larger diameter powders requiring more energy to melt than small diameter powders. It is also critical to keep the small diameter powders from vaporizing, so the real time feedback of the temperature to the laser sources can be used to dial in an average region temperature that is sufficient to melt the large powder particles but insufficient to vaporize the smaller powder particles.

Examples of systems, processing, configurations and methods of embodiments of the present systems and methods are set forth in Table I.

TABLE I

| | | | Spot | | | | | | | |
|---|---|---|---|---|---|---|---|---|---|---|
| | | Power | Diameter | | | | | Secondary | | |
| | | of Each | of | Number | Number | Power of | Secondary | Laser | Secondary | |
| | Layer | Primary | Each | of | of | secondary | Spot Preheat | Beam | Laser Beam | Build |
| | Thickness | Laser | Primary | Primary | Primary | laser beam | Temperature | Spot Size | Spot Size | Rate |
| Material | (μm) | (Watts) | Laser (μm) | Spots X | Spots Y | (Watts) | (° C.) | (μm) (X) | (μm) (Y) | (CC/hr) |
| Cu | 100 | 100 | 200 | 1 | 1 | 1 | 21 | 200 | 200 | 54 |
| Cu | 100 | 100 | 200 | 1 | 2 | 1 | 21 | 200 | 400 | 108 |
| Cu | 100 | 100 | 200 | 1 | 3 | 1 | 21 | 200 | 600 | 162 |
| Cu | 100 | 100 | 200 | 1 | 1 | 100 | 200 | 200 | 200 | 61 |
| Cu | 100 | 100 | 200 | 1 | 2 | 100 | 200 | 200 | 400 | 122 |
| Cu | 100 | 100 | 200 | 1 | 3 | 100 | 200 | 200 | 600 | 183 |
| Cu | 100 | 100 | 200 | 1 | 1 | 100 | 600 | 200 | 200 | 85 |
| Cu | 100 | 100 | 200 | 1 | 2 | 200 | 600 | 200 | 400 | 170 |
| Cu | 100 | 100 | 200 | 1 | 3 | 400 | 600 | 200 | 600 | 226 |
| Cu | 100 | 100 | 200 | 1 | 1 | 100 | 600 | 200 | 200 | 85 |
| Cu | 100 | 100 | 200 | 1 | 5 | 200 | 600 | 200 | 1000 | 68 |
| Cu | 100 | 100 | 200 | 1 | 10 | icon | 600 | 200 | 2000 | 170 |
| Cu | 100 | 100 | 200 | 1 | 10 | 400 | 600 | 200 | 2000 | 68 |
| Cu | 100 | 100 | 200 | 1 | 10 | 1000 | 600 | 200 | 2000 | 170 |
| Cu | 100 | 100 | 200 | 1 | 10 | 2500 | 600 | 200 | 2000 | 424 |
| Cu | 100 | 100 | 200 | 4 | 10 | 4000 | 600 | 800 | 2000 | 170 |
| Cu | 100 | 100 | 200 | 4 | 10 | 5000 | 600 | 800 | 2000 | 212 |
| Cu | 100 | 100 | 200 | 4 | 10 | 12000 | 600 | 300 | 2000 | 509 |
| Al | 100 | 100 | 200 | 1 | 1 | 1 | 21 | 200 | 200 | 67 |
| Al | 100 | 100 | 200 | 1 | 2 | 1 | 21 | 200 | 400 | 133 |
| Al | 100 | 100 | 200 | 1 | 3 | 1 | 21 | 200 | 600 | 200 |
| Al | 100 | 100 | 200 | 1 | 1 | 100 | 200 | 200 | 200 | 117 |
| Al | 100 | 100 | 200 | 1 | 2 | 100 | 200 | 200 | 400 | 234 |
| Al | 100 | 100 | 200 | 1 | 3 | 100 | 200 | 200 | 600 | 351 |
| Al | 100 | 100 | 200 | 1 | 1 | 150 | 400 | 200 | 200 | 164 |
| Al | 100 | 100 | 200 | 1 | 2 | 400 | 400 | 200 | 400 | 218 |
| Al | 100 | 100 | 200 | 1 | 3 | 800 | 400 | 200 | 600 | 291 |
| Al | 100 | 100 | 200 | 1 | 1 | 100 | 400 | 200 | 200 | 109 |
| Al | 100 | 100 | 200 | 1 | 5 | 500 | 400 | 200 | 1000 | 131 |
| Al | 100 | 100 | 200 | 1 | 10 | 2000 | 400 | 200 | 2000 | 218 |
| Al | 100 | 100 | 200 | 1 | 10 | 400 | 400 | 200 | 2000 | 44 |
| Al | 100 | 100 | 200 | 1 | 10 | 1000 | 400 | 200 | 2000 | 109 |
| Al | 100 | 100 | 200 | 1 | 10 | 2500 | 400 | 200 | 2000 | 273 |
| Al | 100 | 100 | 200 | 4 | 10 | 4000 | 400 | 800 | 2000 | 109 |
| Al | 100 | 100 | 200 | 4 | 10 | 5000 | 400 | 800 | 2000 | 136 |
| Al | 100 | 100 | 200 | 4 | 10 | 12000 | 400 | 800 | 2000 | 327 |
| SS304 | 100 | 100 | 200 | 1 | 1 | 1 | 21 | 200 | 200 | 26 |
| SS304 | 100 | 100 | 200 | 1 | 2 | 1 | 21 | 200 | 400 | 52 |
| SS304 | 100 | 100 | 200 | 1 | 3 | 1 | 21 | 200 | 600 | 78 |
| SS304 | 100 | 100 | 200 | 1 | 1 | 100 | 200 | 200 | 200 | 29 |
| SS304 | 100 | 100 | 200 | 1 | 2 | 100 | 200 | 200 | 400 | 57 |
| SS304 | 100 | 100 | 200 | 1 | 3 | 200 | 200 | 200 | 600 | 86 |
| SS304 | 100 | 100 | 200 | 1 | 1 | 200 | 600 | 200 | 200 | 37 |
| SS304 | 100 | 100 | 200 | 1 | 2 | 200 | 600 | 200 | 400 | 75 |
| SS304 | 100 | 100 | 200 | 1 | 3 | 600 | 600 | 200 | 600 | 112 |
| SS304 | 100 | 100 | 200 | 1 | 1 | 100 | 600 | 200 | 200 | 37 |
| SS304 | 100 | 100 | 200 | 1 | 5 | 500 | 600 | 200 | 1000 | 97 |
| SS304 | 100 | 100 | 200 | 1 | 10 | 3000 | 600 | 200 | 2000 | 290 |
| SS304 | 100 | 100 | 200 | 1 | 10 | 600 | 600 | 200 | 2000 | 58 |
| SS304 | 100 | 100 | 200 | 1 | 10 | 2000 | 600 | 200 | 2000 | 194 |
| SS304 | 100 | 100 | 200 | 1 | 10 | 5000 | 600 | 200 | 2000 | 373 |
| SS304 | 100 | 100 | 200 | 4 | 10 | 6000 | 600 | 800 | 2000 | 145 |
| SS304 | 100 | 100 | 200 | 4 | 10 | 10000 | 600 | 800 | 2000 | 242 |
| SS304 | 100 | 100 | 200 | 4 | 10 | 18000 | 600 | 800 | 2000 | 435 |

Further, and in general embodiments of the present inventions relate to the combining of laser beams, systems for making these combinations and processes utilizing the combined beams. In particular, the present inventions relate to arrays, assemblies and devices for combining laser beams from several laser beam sources into one or more combined laser beams. These combined laser beams preferably have preserved, enhanced, and both, various aspects and properties of the laser beams from the individual sources.

Embodiments of the present array assemblies, and the combined laser beams that they provide can find wide-ranging applicability. Embodiments of the present array assemblies are compact and durable. Embodiments of the present array assemblies have applicability in welding, additive manufacturing, including 3-D printing; additive manufacturing—milling systems, e.g., additive and subtractive manufacturing; astronomy; meteorology; imaging; projection, including entertainment; and medicine, including dental, to name a few.

Although this specification focuses on blue laser diode arrays, it should be understood that this embodiment is only illustrative of the types of array assemblies, systems, processes and combined laser beams contemplated by the present inventions. Thus, embodiments of the present inventions include array assemblies for combining laser beam from various laser beam sources, such as solid-state lasers, fiber lasers, semiconductor lasers, as well as other types of lasers and combinations and variations of these. Embodiments of the present invention include the combining of laser beams across all wavelengths, for example laser beams having wavelengths from about 380 nm to 800 nm (e.g., visible light), from about 400 nm to about 880 nm, from about 100 nm to about 400 nm, from 700 nm to 1 mm, and combinations, variations of particular wavelengths within these various ranges. Embodiments of the present arrays may also find application in microwave coherent radiation (e.g., wavelength greater than about 1 mm). Embodiments of the present arrays can combine beams from one, two, three, tens, or hundreds of laser sources. These laser beams can have from a few milliwatts, to watts, to kilowatts.

An embodiment of the present invention consists of an array of blue laser diodes that are combined in a configuration to preferably create a high brightness laser source. This high brightness laser source may be used directly to process materials, i.e. marking, cutting, welding, brazing, heat treating, annealing. The materials to be processed, e.g., starting materials or target materials, can include any material or component or composition, and for example, can include semiconductor components such as but not limited to TFTs (thin film transistors), 3-D printing starting materials, metals including gold, silver, platinum, aluminum and copper, plastics, tissue, and semiconductor wafers to name a few. The direct processing may include, for example, the ablation of gold from electronics, projection displays, and laser light shows, to name a few.

Embodiments of the present high brightness laser sources may also be used to pump a Raman laser or an Anti-Stokes laser. The Raman medium may be a fiber optic, or a crystal such as diamond, KGW (potassium gadolinium tungstate, KGd(WO₄)₂), YVO₄, and Ba(NO₃)₂. In an embodiment the high brightness laser sources are blue laser diode sources, which are a semiconductor device operating in the wavelength range of 400 nm to 500 nm. The Raman medium is a brightness convertor and is capable of increasing the brightness of the blue laser diode sources. The brightness enhancement may extend all the way to creating a single mode, diffraction limited source, i.e., beam having an M² of about 1 and 1.5 with beam parameter products of less than 1, less than 0.7, less than 0.5, less than 0.2 and less than 0.13 mm-mrad depending upon wavelength.

In an embodiment “n” or “N” (e.g., two, three, four, etc., tens, hundreds, or more) laser diode sources can be configured in a bundle of optical fibers that enables an addressable light source that can be used to mark, melt, weld, ablate, anneal, heat treat, cut materials, and combinations and variations of these, to name a few laser operations and procedures.

An embodiment of a laser system with an addressable laser delivery configuration. The system has an addressable laser diode system. The system provides independently addressable laser beams to a plurality of fibers (greater and lower numbers of fibers and laser beams are contemplated). The fibers are combined into a fiber bundle that is contained in a protective tube, or cover. The fibers in fiber bundle are fused together to form a printing head that includes an optics assembly that focuses and directs the laser beams, along beam paths, to a target material. The print head and the powder hoppers move together with the movement of the print head being in the positive direction according to. Additional material can be placed on top of the fused material with each pass of the print head or hopper. The print head is bi-directional and will fuse material in both directions as the print head moves, so the powder hoppers operate behind the print head providing the buildup material to be fused on the next pass of the laser printing head.

By “addressable array” it is meant that one or more of: the power; duration of firing; sequence of firing; position of firing; the power of the beam; the shape of the beam spot, as well as, the focal length, e.g., depth of penetration in the z-direction, can be independently varied, controlled and predetermined or each laser beam in each fiber to provide precise and predetermined delivery patterns that can create from the target material highly precise end products (e.g., built materials) Embodiments of addressable arrays can also have the ability for individual beams and laser stops created by those beam to perform varied, predetermined and precise laser operations such as annealing, ablating, and melting.

The following examples are provided to illustrate various embodiments of laser arrays, systems, apparatus and methods of the present inventions. These examples are for illustrative purposes and should not be viewed as, and do not otherwise limit the scope of the present inventions.

### Example 1

An array of blue laser diodes that are spatially combined to make a single spot in the far-field that can be coupled into a Solarization resistant optical fiber for delivery to the work piece.

### Example 2

An array of blue laser diodes as described in Example 1 that are polarization beam combined to increase the effective brightness of the laser beam.

### Example 3

An array of blue laser diodes with space between each of the collimated beams in the fast axis of the laser diodes that are then combined with a periodic plate which reflects the first laser diode(s) and transmits a second laser diode(s) to fill the space between the laser diodes in the fast direction of the first array.

### Example 4

A patterned mirror on a glass substrate that is used to accomplish the space filling of Example 3.

### Example 5

A patterned mirror on one side of the glass substrate to accomplish the space filling of Example 3 and the glass substrate is of sufficient thickness to shift the vertical position of each laser diode to fill the empty space between the individual laser diodes.

### Example 6

A stepped heat sink that accomplishes the space filling of Example 3 and is a patterned mirror as described in Example 4.

### Example 7

An array of blue laser diodes as described in Example 1 where each of the individual lasers are locked by an external cavity to a different wavelength to substantially increase the brightness of the array to the equivalent brightness of a single laser diode source.

### Example 8

An array of blue laser diodes as described in Example 1 where individual arrays of laser diodes are locked to single wavelength using an external cavity based on a grating and each of the laser diode arrays are combined into a single beam using either narrowly spaced optical filters or gratings.

### Example 9

An array of blue laser diodes as described in Example 1 that is used to pump a Raman convertor such as an optical fiber that has a pure fused silica core to create a higher brightness source and a fluorinated outer core to contain the blue pump light.

### Example 10

An array of blue laser diodes as described in Example 1 that is used to pump a Raman convertor such as an optical fiber that has a GeO₂ doped central core with an outer core to create a higher brightness source and an outer core that is larger than the central core to contain the blue pump light.

### Example 11

An array of blue laser diodes as described in Example 1 that is used to pump a Raman convertor such as an optical fiber that has a P₂O₅ doped core to create a higher brightness source and an outer core that is larger than the central core to contain the blue pump light.

### Example 12

An array of blue laser diodes as described in Example 1 that is used to pump a Raman convertor such as an optical fiber that has a graded index core to create a higher brightness source and an outer core that is larger than the central core to contain the blue pump light.

### Example 13

An array of blue laser diodes as described in Example 1 that is used to pump a Raman convertor fiber that is a graded index GeO₂ doped core and an outer step index core.

### Example 14

An array of blue laser diodes as described in Example 1 that is used to pump a Raman convertor fiber that is a graded index P₂O₅ doped core and an outer step index core.

### Example 15

An array of blue laser diodes as described in Example 1 that is used to pump a Raman convertor fiber that is a graded index GeO₂ doped core.

### Example 16

An array of blue laser diodes as described in Example 1 that is used to pump a Raman convertor fiber that is a graded index P₂O₅ doped core and an outer step index core.

### Example 17

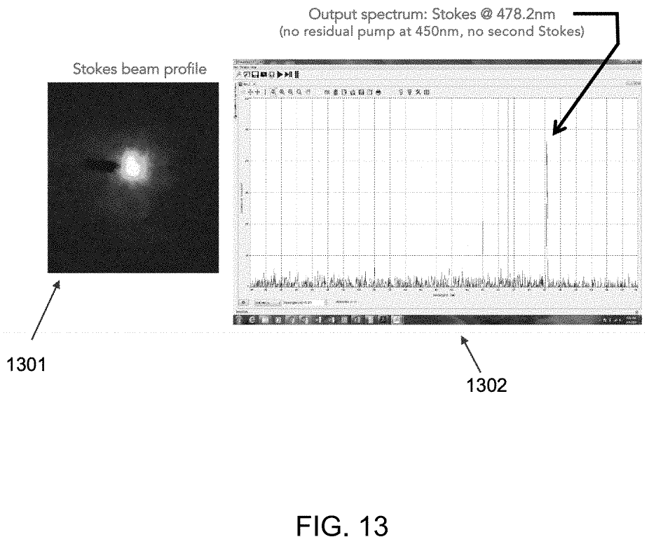

Other embodiments and variations of the embodiment of Example 1 are contemplated. An array of blue laser diodes as described in Example 1 that is used to pump a Raman convertor such as diamond to create a higher brightness laser source. FIG. 13 shows an image 1301 and spectrum 1302 of a blue Raman converted laser beam from a diamond chip and the shift in wavelength from 450 nm to 478 nm. An array of blue laser diodes as described in Example 1 that is used to pump a Raman convertor such as KGW to create a higher brightness laser source. An array of blue laser diodes as described in Example 1 that is used to pump a Raman convertor such as YVO₄ to create a higher brightness laser source. An array of blue laser diodes as described in Example 1 that is used to pump a Raman convertor such as Ba(NO₃)₂ to create a higher brightness laser source. An array of blue laser diodes as described in Example 1 that is used to pump a Raman convertor that is a high pressure gas to create a higher brightness laser source. An array of blue laser diodes as described in Example 1 that is used to pump a rare-earth doped crystal to create a higher brightness laser source. An array of blue laser diodes as described in Example 1 that is used to pump a rare-earth doped fiber to create a higher brightness laser source. An array of blue laser diodes as described in Example 1 that is used to pump an outer core of a brightness convertor to create a higher ratio of brightness enhancement.

### Example 18

An array of Raman converted lasers that are operated at individual wavelengths and combined to create a higher power source while preserving the spatial brightness of the original source.

### Example 19

An Raman fiber with dual cores and a means to suppress the second order Raman signal in the high brightness central core using a filter, fiber Bragg grating, difference in V number for the first order and second order Raman signals or a difference in micro-bend losses.

### Example 20

N laser diodes where N≥1 that can be individually turned on and off and can be imaged onto a bed of powder to melt and fuse the powder into a unique part.

### Example 21

N laser diode arrays where N≥1 of Example 1 whose output can be fiber coupled and each fiber can be arranged in a linear or non-linear fashion to create an addressable array of high power laser beams that can be imaged or focused onto a powder to melt or fuse the powder into a unique shape layer by layer.

### Example 22

One or more of the laser diode arrays combined via the Raman convertor whose output can be fiber coupled and each fiber can be arranged in a linear or non-linear fashion to create an addressable array of N where N≥1 high power laser beams that can be imaged or focused onto a powder to melt or fuse the powder into a unique shape layer by layer.

### Example 23

An x-y motion system that can transport the N where N≥1 blue laser source across a powder bed while melting and fusing the powder bed with a powder delivery system positioned behind the laser source to provide a fresh powder layer behind the fused layer.

### Example 24

A z-motion system that can increment/decrement the height of the part/powder bed of Example 20 after a new layer of powder is placed.

### Example 25

A z-motion system can increment/decrement the height of the part/powder of Example 20 after the powder layer has been fused by the laser source.

### Example 26

A bi-directional powder placement capability for Example 20 where the powder is placed directly behind the laser spot(s) as it travels in the positive x direction or the negative x direction.

### Example 27

A bi-directional powder placement capability for Example 20 where the powder is placed directly behind the laser spot(s) as it travels in the positive y direction or the negative y direction.

### Example 28

A powder feed system which is coaxial with N laser beams where N≥1.

### Example 29

A powder feed system where the powder is gravity fed.

### Example 30

A powder feed system where the powder is entrained in an inert gas flow.

### Example 31

A powder feed system which is transverse to the N laser beams where

N≥1 and the powder is placed by gravity just ahead of the laser beams.

### Example 32

A powder feed system which is transverse to the N laser beams where N≥1 and the powder is entrained in an inert gas flow which intersects the laser beams.

### Example 33

A second harmonic generation system which uses the output of the Raman convertor at for example 460 nm to generate light at half the wavelength of the source laser or 230 nm that consists of an externally resonant doubling crystal such as KTP but does not allow the short wavelength light to propagate through the optical fiber.

### Example 34

A third harmonic generation system which uses the output of the Raman convertor at for example 460 nm to generate light at 115 nm using an externally resonant doubling crystal but does not allow the short wavelength light to propagate through the optical fiber.

### Example 35

A fourth harmonic generation system which uses the output of the Raman convertor at for example 460 nm to generate light at 57.5 nm using an externally resonant doubling crystal but does not allow the short wavelength light to propagate through the optical fiber.

### Example 36

A second harmonic generation system which uses the output of a rare-earth doped brightness convertor such as Thulium that lases at 473 nm when pumped by an array of blue laser diodes at 450 nm to generate light at half the wavelength of the source laser or 236.5 nm using an externally resonant doubling crystal but does not allow the short wavelength light to propagate through the optical fiber.

### Example 37

A Third harmonic generation system which uses the output of a rare-earth doped brightness convertor such as Thulium that lases at 473 nm when pumped by an array of blue laser diodes at 450 nm to generate light at 118.25 nm using an externally resonant doubling crystal but does not allow the short wavelength light to propagate through the optical fiber.

### Example 38

A fourth harmonic generation system which uses the output of a rare-earth doped brightness convertor such as Thulium that lases at 473 nm when pumped by an array of blue laser diodes at 450 nm to generate light at 59.1 nm using an externally resonant doubling crystal but does not allow the short wavelength light to propagate through the optical fiber.

### Example 39

All other rare-earth doped fibers and crystals that can be pumped by a high power 450 nm source to generate visible, or near-visible output can be used in Examples 34-38.

### Example 40

Launch of high-power visible light into a non-circular outer core or clad to pump the inner core of either the Raman or rare-earth doped core fiber.

### Example 41

Use of polarization maintaining fiber to enhance the gain of the Raman fiber by aligning the polarization of the pump with the polarization of the Raman oscillator.

### Example 42

An array of blue laser diodes as described in Example 1 that is used to pump a Raman convertor such as an optical fiber that is structured to create a higher brightness source of a specific polarization.

### Example 43

An array of blue laser diodes as described in Example 1 that is used to pump a Raman convertor such as an optical fiber that is structured to create a higher brightness source of a specific polarization and maintain the polarization state of the pump source.

### Example 44

An array of blue laser diodes as described in Example 1 that is used to pump a Raman convertor such as an optical fiber to create a higher brightness source with a non-circular outer core structured to improve Raman conversion efficiency.

### Example 45

The embodiments of Examples 1 to 44 may also include one or more of the following components or assemblies: a device for leveling the powder at the end of each pass prior to the laser being scanning over the powder bed; a device for scaling the output power of the laser by combining multiple low power laser modules via a fiber combiner to create a higher power output beam; a device for scaling the output power of the blue laser module by combing multiple low power laser modules via free space to create a higher power output beam; a device for combining multiple laser modules on a single baseplate with imbedded cooling.

It is noted that there is no requirement to provide or address the theory underlying the novel and groundbreaking performance or other beneficial features and properties that are the subject of, or associated with, embodiments of the present inventions. Nevertheless, various theories are provided in this specification to further advance the art in this important area, and in particular in the important area of lasers, laser processing and laser applications. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the operation, function and features of embodiments of the methods, articles, materials, devices and system of the present inventions; and such later developed theories shall not limit the scope of protection afforded the present inventions.

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

The various embodiments of lasers, diodes, arrays, modules, assemblies, activities and operations set forth in this specification may be used in the above identified fields and in various other fields. Among others, embodiments of the present inventions can be used with the methods, devices and system of Patent Application Publication Nos. WO 2014/179345, 2016/0067780, 2016/0067827, 2016/0322777, 2017/0343729, 2017/0341180, and 2017/0341144 the entire disclosure of each of which are incorporated herein by reference. Additionally, these embodiments, for example, may be used with: existing lasers, additive manufacturing systems, operations and activities as well as other existing equipment; future lasers, additive manufacturing systems operations and activities; and such items that may be modified, in-part, based on the teachings of this specification. Further, the various embodiments set forth in this specification may be used with each other in different and various combinations. Thus, for example, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. Thus, the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. An additive manufacturing system comprising a light source configured to provide a multi-spot 1-D image, a multi-spot 2-D image or both on a powder bed; wherein the images have a sufficient power density to fuse and build a part from the powder.

2. The light source of claim 1 comprises an array of fibers coupling light from an array of fiber Raman lasers operating in the wavelength range of 300 nm to 500 nm.

3. The light source of claim 1 comprises an array of laser diodes operating in the wavelength range of about 400 nm to about 500 nm.

4. The light source of claim 1 comprises an array of optical fibers coupled to laser diodes operating in the wavelength range of about 400 nm to about 500 nm.

5. The light source of claim 1, 2, 3, or 4, comprising an array of optical fibers having diameters selected from the group consisting of 10 μm to 50 μm, 50 μm to 100 μm, and 100 μm to 500 μm,

6. The light sources of claim 1, 2, 3, or 4, comprising a single bundle of individual optical fibers coupled to individual light sources that is reimaged with an optic that can be 1:0.5, 1:1, 1:2 up to and including 1:10.

7. The light source in claim 1 is a bundle of fibers mounted in a single QBH connector.

8. The light source in claim 1 is individual fibers mounted independently.

9. The system of claim 1, comprising a high resolution thermal imaging camera for directly monitoring the temperature in each spot during operation and providing a feedback signal to a microprocessor that controls the power to each spot and therefore the build quality of the part on a spot by spot basis.

10. The system of claim 1, comprising a pyrometer array for directly monitoring the temperature in each spot during operation and providing a feedback signal to a microprocessor that controls the power to each spot and therefore the build quality of the part on a spot by spot basis.

11. The systems of any one of claims 1-4, comprising a print head consisting of an array of light sources that is mounted on an x-y gantry system for translating the 1-D or 2-D image across the surface of the powder bed.

12. The additive manufacturing system in claim 1 that uses a gravity fed powder delivery system that operating in both directions.

13. The additive manufacturing system in claim 1 that includes a rotating wheel, moving opposite to the direction of the hopper travel, to compress and compact the powder, reducing the porosity of the powder bed.

14. The control signal in claim 85 comprises a signal proportional to the temperature of the powder bed.

15. The control signal in claim 85 comprises a signal proportional to the temperature of the melt puddle produced at each point of the 1-D or 2-D image on the powder bed.

16. The additive manufacturing system in claim 1 uses a blue laser source for fusing copper powders.

17. The additive manufacturing system in claim 1 uses a blue laser source for fusing gold powders.

18. The additive manufacturing system in claim 1 uses a blue laser source to fuse aluminum powders.

19. The additive manufacturing system in claim 1 uses a blue laser source to fuse a material comprising a metal.

20. The systems of claim 1, comprising a print head consisting of an array of light sources that is mounted on an x-y gantry system for translating the 1-D or 2-D image across the surface of the powder bed; and wherein the print head integrates an optical system with a thermal imaging camera system to reimage and control the temperature of the powder in the regions exposed to the fiber array or diode array image.

21. The optical system in the print head of claim 20 consists of a collimator that may be a plano-convex lens, a plano-convex asphere lens, a doublet or a triplet lens pair and the focusing optic consists of a plano-convex lens, a plano-convex asphere lens, here the source is if away from the collimating lens and if away from the focusing lens.

22. The optical system in the print head of claim 20 is a reimaging optic with the source at least 2f away from the lens and the image at least 2f away from the lens in the opposite direction.

23. (canceled)

24. An additive manufacturing system based on an array of light sources and a secondary light source for controlling the temperature of the build area which is a 1-D or 2-D image on a powder bed at a sufficient power density to fuse and build a part with a camera system to monitor each pixel of the image and feedback in real time a control signal to each laser to control the melting and fusing of the powder to optimize the surface roughness, porosity and stress in the resulting part.

25. (canceled)

26. The light source in claim 24 is an array of laser diodes operating in the wavelength range of 400 nm to 500 nm.

27. (canceled)

28. The light source in claim 24 is delivered by an array of optical fibers ranging in diameters of 10 μm to 50 μm, 50 μm to 100 μm, or 100 μm to 500 μm.

29. The light source in claim 24 is a single bundle of individual optical fibers coupled to individual light sources that is reimaged with an optic that can be 1:0.5, 1:1, 1:2 up to and including 1:10.

30. (canceled)

31. (canceled)

32. (canceled)

33. The secondary light source in claim 24 is a laser diode system operating in the wavelength range of 400 nm to 500 nm.

34. The secondary light source in claim 24 is imaged onto the same area as the 1-D or 2-D pattern is imaged.

35. (canceled)

36. (canceled)

37. (canceled)

38. The camera in claim 24 is a pyrometer array for directly monitoring the temperature in each spot during operation and providing a feedback signal to a microprocessor that controls the power to each spot and therefore the build quality of the part on a spot by spot basis.

39. (canceled)

40. (canceled)

41. (canceled)

42. The control signal in claim 24 can be a signal proportional to the temperature of the powder bed.

43. The control signal in claim 24 can be a signal proportional to the temperature of the melt puddle produced at each point of the 1-D or 2-D image on the powder bed.

44. The additive manufacturing system in claim 24 uses a blue laser source for fusing copper powders.

45. (canceled)

46. (canceled)

47. The additive manufacturing system in claim 24 uses a blue laser source to fuse a material comprising a metal.

48. (canceled)

49. (canceled)

50. (canceled)

51. The additive manufacturing systems in claim 1 or 24 incorporate an Optical Coherence Tomography (OCT) system to monitoring the welding process in real time.

52. An additive manufacturing system based on an array of light sources and an array (n×m>1) of secondary light sources for controlling the temperature of the build area which is a 1-D or 2-D image on a powder bed at a sufficient power density to fuse and build a part with a camera system to monitor each pixel of the image and feedback in real time a control signal to each laser to control the melting and fusing of the powder to optimize the surface roughness, porosity and stress in the resulting part.

53. (canceled)

54. The light source in claim 53 is an array of laser diodes operating in the wavelength range of 400 nm to 500 nm.

55. (canceled)

56. (canceled)

57. (canceled)

58. (canceled)

59. (canceled)

60. The secondary light source in claim 53 is a fiber Raman laser operating in the wavelength range of 300 nm to 500 nm.

61. (canceled)

62. (canceled)

63. The temperature of the powder irradiated by the secondary array of light sources in claim 53 is measured by a thermal imaging camera and the signal from the camera is used to control the average temperature of the illuminated zone.

64. (canceled)

65. (canceled)

66. The camera in claim 53 is a pyrometer array for directly monitoring the temperature in each spot during operation and providing a feedback signal to a microprocessor that controls the power to each spot and therefore the build quality of the part on a spot by spot basis.

67. (canceled)

68. (canceled)

69. (canceled)

70. (canceled)

71. (canceled)

72. (canceled)

73. The print head for the additive manufacturing system in claim 1 integrates an optical system with a thermal imaging camera system to reimage and control the temperature of the powder in the regions exposed to the fiber array or diode array image.

74. (canceled)

75. (canceled)

76. The additive manufacturing system in claim 53 uses a blue laser source for fusing copper powders.

77. (canceled)

78. (canceled)

79. The additive manufacturing system in claim 53 uses a blue laser source to optimally fuse a material comprising a metal.

80. (canceled)

81. The printer heads in claims 1, 24 and 53 are mounted with similar printer heads on a single or multiple gantries to print the image which is a portion of a part.

82. The printer heads in claims 1, 24 and 53 are mounted with similar printer heads on a single or multiple gantries and an optical system is used to fuse the image from multiple sources together to create a larger contiguous image.

83. The printer heads in claims 1, 24, and 53 are mounted with similar printer heads on a single or multiple gantries to print an image in a checkboard fashion which are fused together by step and repeat of interstitial patterns.

84. The system of claim 1 comprising a camera system to monitor each pixel of the image and feedback in real time a control signal to each laser to control the melting and fusing of the powder to optimize the surface roughness, porosity and stress in the resulting part.
